(19) United States
(12) Patent Application Publication
(10) Pub. No.: US 2010/0025079 A1
(43) Pub. Date: Feb. 4, 2010

(54) ELECTRICAL BONDING DEVICE FOR TELESCOPING FLUID LINE ASSEMBLY

(76) Inventor: William T. Flynn, Horton, MI (US)

Correspondence Address: EATON CORPORATION;EATON CENTER, 1111 SUPERIOR AVENUE, CLEVELAND, OH, 44114, US

(21) Appl. No.: 12/183,447

(22) Filed: Jul. 31, 2008

(51) Int. Cl. H02G 15/08; F16L 55/00

(52) U.S. Cl. 174/21 JS; 138/108; 138/109; 138/112; 285/319; 285/330

(57) ABSTRACT

The present application is directed to a fluid line assembly comprising a first fluid conveying conduit, a second fluid conveying conduit, and a slip joint. The slip joint includes a first fluid conveying conduit section, a second fluid conveying conduit section positioned radially outwardly from and at least partially surrounding the first conduit section, and an electrical bonding device positioned between and contacting the first and second fluid conveying conduit sections to form an electrical path therebetween. The electrical resistance between the first and second fluid conveying conduits is generally constant during relative movement therebetween.

Further, in the accompanying drawings and description that follow, like parts are indicated throughout the drawings and description with the same reference numerals, respectively. The figures may not be drawn to scale and the proportions of certain parts have been exaggerated for convenience of illustration.

FIG. 1 is a prior art fluid conveying device.

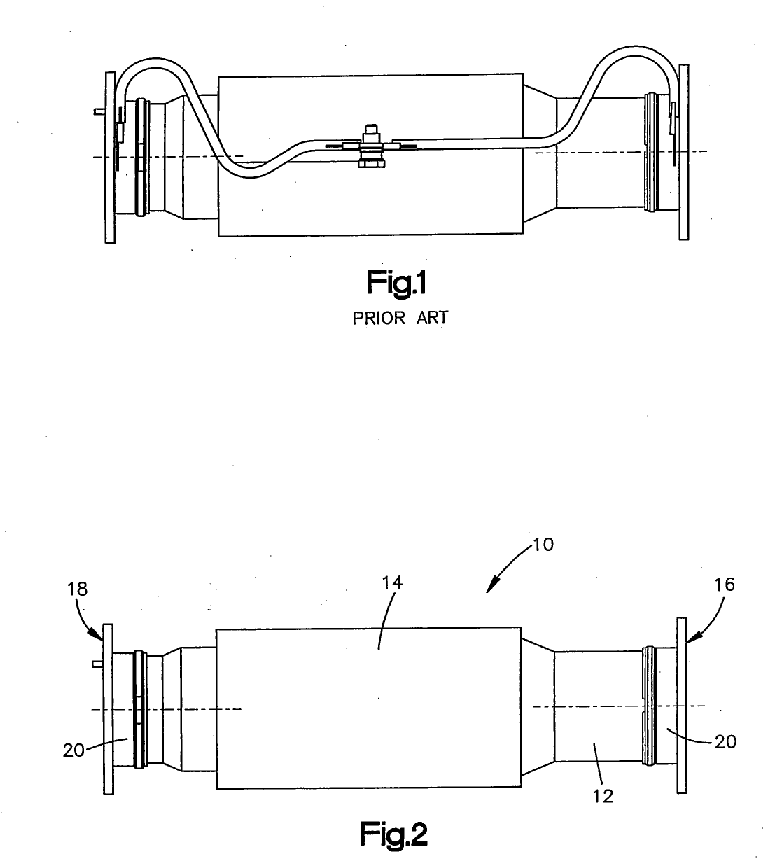

FIG. 2 is a fluid line assembly according to an embodiment of the present invention.

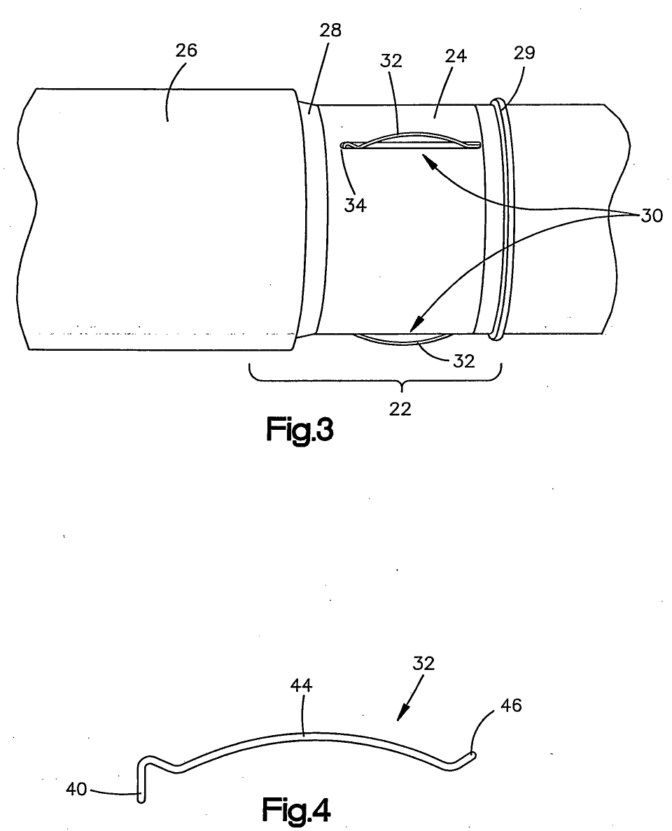

FIG. 3 is a slip joint according to an embodiment of the present invention, shown partially assembled, which may be used in the fluid line assembly of FIG. 2.

FIG. 4 is an electrical bonding member according to an embodiment of the present invention, which may be used in the slip joint of FIG. 3.

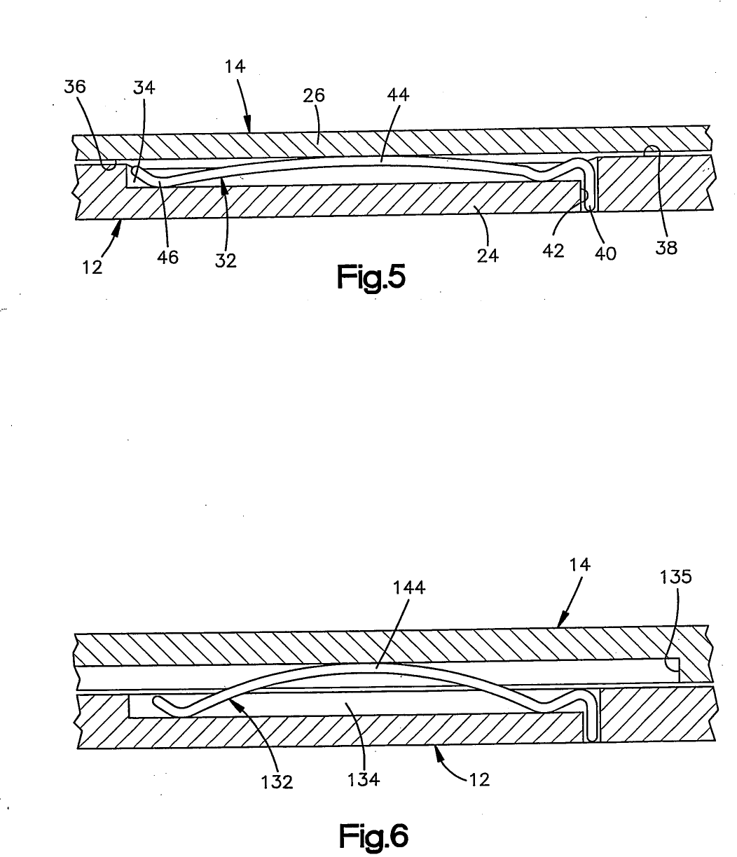

FIG. 5 is a cross-sectional view of the slip joint of FIG. 3 shown in the assembled condition.

FIG. 6 is a cross-sectional view of a slip joint according to another embodiment of the present invention.

### DETAILED DESCRIPTION

Referring to FIG. 2, a fluid line assembly 10 is shown that includes a first fluid conveying conduit 12 and a second fluid conveying conduit 14. First and second fluid conveying conduits 12, 14 are generally tubular in shape and sized such that first conduit 12 may move (e.g., axially, rotationally) within second conduit 14. Fluid line assembly 10 extends from a first end 16 to a second end 18. While the fluid line assembly 10 illustrated in FIG. 2 is a telescoping fluid line assembly, it not limited thereto and may include other flexible configurations.

Each end 16, 18 includes a coupling 20 for attaching fluid line assembly 10 to another structure, such as a fuel tank. It will be appreciated that any type of coupling 20 may be attached to ends 16 and 18, including, without limitation, flanges, threaded couplings, ball joints, quick connect/disconnect couplings, or other types of couplings. Furthermore, the couplings 20 are not limited to a specific size and can cover a wide range of both conventional and unconventional sizes. Fluid conveying conduits 12, 14 and couplings 20 may be constructed of a metallic material, such as aluminum, titanium, stainless steel or an electrically conductive composite material. It will be appreciated that the conduit and coupling materials are not necessarily limited thereto, provided that the fluid line assembly satisfies the mechanical and electrical requirements of a given installation.

Referring to FIG. 3, fluid line assembly 10 also includes a slip joint 22 including a first fluid conveying conduit section 24 and a second fluid conveying conduit section 26 positioned radially outwardly from and at least partially surrounding the first fluid conveying conduit section 24. At least one bearing member 28 (e.g., polymeric or metallic or a combination of polymeric material powered metal filled) and a sealing member 30 (e.g., O-ring seal, quad seal, Tee seal, spring energized U-cup seal) may be positioned between first and second conduit sections 24, 26 to facilitate movement and inhibit fluid leakage, respectively, therebetween.

An electrical bonding device 30 is also positioned between and contacts first and second fluid conveying conduit sections 24, 26 to form an electrical path therebetween. In an embodiment, electrical bonding device 30 includes at least one cantilevered, generally resilient, electrical bonding member 32. Like fluid conveying conduits 12, 14, electrical bonding member 32 may be constructed of a metallic material, such as spring tempered alloy or spring tempered stainless steel; however, it will be appreciated that the material is not necessarily limited thereto, provided the material also satisfies the mechanical and electrical requirements of a given installation (e.g. spring tempered electrically conductive polymeric material).

In an embodiment of the invention, electrical bonding member 32 is received in an axially extending groove 34 in one of first and second conduits 12, 14. When contained in outer conduit 14, groove 34 is provided in an inner surface 36 of conduit 14, and when contained in the inner conduit 12, groove 34 is provided in an outer surface 38 of conduit 12. As conduit 12 is inserted into conduit 14 to form slip joint 22, electrical bonding member 32 engages the adjacent conduit and is compressed within groove 34 to electrically bond the otherwise electrically isolated conduits 12, 14.

In an embodiment of the invention, electrical bonding device 30 includes a number (N) of electrical bonding members 32—the number (N) being determined by the electrical bonding resistance required between first and second conduits 12, 14. The total electrical resistance between first and second conduits 12, 14 is generally dependant on: i) the resistively of the materials employed in first and second conduits 12, 14 and electrical bonding member 32; ii) the contact surface area between first and second conduits 12, 14 and electrical bonding member 32; iii) the force of contact between first and second conduits 12, 14 and electrical bonding member 32; and iv) the shape and dimensions of first and second conduits 12, 14 and electrical bonding member 32. Any or all of these parameters may be modified to obtain the desired electrical bonding resistance. Generally, an increase in the number (N) of electrical bonding members 32 will reduce the electrical resistance measured between the first and second conduits 12, 14.

Referring to the embodiment shown in FIGS. 4 and 5, a first end of electrical bonding member 32 includes a tab 40 received in a corresponding receptacle 42 located in groove 34 to inhibit axial movement of electrical bonding member 32 within groove 34. Prior to assembly of fluid line assembly 10, a generally elliptical cantilevered portion 44 of electrical bonding member 32 extends outward from outer 38 or inner 36 surface a predetermined distance. This distance effects the amount of compression and, accordingly, the contact force between the engaging surfaces of conduits 12, 14 and electrical bonding member 32. A distal end 46 of bonding member 32 may be turned outward away from the inner surface of groove 34 to facilitate axial movement within groove 34 as bond member 32 is radially compressed during assembly. While a generally elliptical profile is shown in the illustrated embodiment for portion 44, the portion 44 may include other profiles that increase or decrease the contact surface area between conduits 12, 14 and electrical bonding member 32.

In the fluid line assembly configuration illustrated in FIG. 3, three electrical bonding members 32 are spaced approximately 120° apart to maintain the concentricity of conduits 12, 14 and to balance the forces between the conduits 12, 14. In applications where at least two bearing members 28 are employed to separate and support movement between conduits 12, 14, as few as one electrical bonding member 32 may be used.

Referring to FIG. 6, a slip joint according to another embodiment of the present invention includes an electrical bonding member 132 received in an axially extending groove 134 in one of first and second conduits 12, 14. A second axial groove 135 is included in the other of conduits 12, 14 to receive a cantilevered portion 144 of electrical bonding member 132. As conduit 12 is inserted into conduit 14 to form slip joint 22, electrical bonding member 132 engages the adjacent conduit and is compressed within groove 134 until it is received within groove 135, whereby it is partially uncompressed to engage an inner surface of groove 135. Grooves 135 provide an axially extending, fixed path for electric bonding members 132 and substantially prevent rotation of one conduit 12, 14 relative to the other. The embodiment shown in FIG. 6 is particularly useful in applications that require first and second conduits 12, 14 to remain in substantially the same radial orientation during axial movement of conduits 12, 14 relative to one another.

In the device disclosed in U.S. patent application Ser. No. 11/203,764, the resiliently compressible conductive member may be compressed axially during relative movement of the conduits, increasing the contact force between the conductive member and the mating components and, accordingly, reducing the electrical resistance therebetween. By contrast, compression of electrical bonding member 32 and, accordingly, the electrical resistance between conduits 12, 14 and bonding member 32, remains generally constant during axial or rotational movement of conduit 12 relative to conduit 14. In further contrast to the device disclosed in U.S. patent application Ser. No. 11/203,764, electrical bonding device 30 requires less space and resists relative rotation between conduits 12, 14 in accordance with the amount of force applied by the compressed bonding member 32 against the adjacent conduit. Furthermore the electrical resistance between the conduits can be more readily tailored to a given application by the addition or subtraction of electrical bonding members 32 in a fixed envelope design.

The present invention has been particularly shown and described with reference to the foregoing embodiments, which are merely illustrative of the best modes for carrying out the invention. It should be understood by those skilled in the art that various alternatives to the embodiments of the invention described herein may be employed in practicing the invention without departing from the spirit and scope of the invention as defined in the following claims. It is intended that the following claims define the scope of the invention and that the method and apparatus within the scope of these claims and their equivalents be covered thereby. This description of the invention should be understood to include all novel and non-obvious combinations of elements described herein, and claims may be presented in this or a later application to any novel and non-obvious combination of these elements. Moreover, the foregoing embodiments are illustrative, and no single feature or element is essential to all possible combinations that may be claimed in this or a later application.

What is claimed is:

1. A fluid line assembly, comprising:
a first fluid conveying conduit;
a second fluid conveying conduit; and
a slip joint including a first fluid conveying conduit section, a second fluid conveying conduit section, and an electrical bonding device positioned between and contacting the first and second fluid conveying conduit sections to form an electrical path therebetween, wherein electrical resistance between the first and second fluid conveying conduits is generally constant during relative movement therebetween.

2. The fluid line assembly of claim 1, wherein the first and second fluid conveying conduits are generally tubular in shape and sized such that the first conduit moves within the second conduit.

3. The fluid line assembly of claim 1, wherein the fluid line assembly extends from a first end to a second end, each of the ends including a coupling.

4. The fluid line assembly of claim 1, wherein the slip joint includes at least one of a bearing member and a sealing member positioned between the first and second conduit sections to facilitate movement and inhibit fluid leakage, respectively, therebetween.

5. The fluid line assembly of claim 1, wherein the electrical bonding device includes at least one generally resilient, electrical bonding member.

6. The fluid line assembly of claim 5, wherein the electrical bonding member is received in an axially extending groove in one of the first and second conduits.

7. The fluid line assembly of claim 5, wherein the electrical bonding device includes a number of electrical bonding members.

8. The fluid line assembly of claim 7, wherein the number is determined by the electrical bonding resistance required between the first and second conduits.

9. The fluid line assembly of claim 6, wherein a first end of the electrical bonding member includes a tab received in a corresponding receptacle located in the groove to inhibit axial movement of the electrical bonding member within the groove.

10. The fluid line assembly of claim 5, wherein the electrical bonding member includes a generally elliptical cantilevered portion.

11. The fluid line assembly of claim 5, where in the electrical bonding device includes three electrical bond members spaced approximately apart to maintain the concentricity of conduits and to balance the forces between the conduits.

12. The fluid line assembly of claim 5, wherein the electrical bonding member is received in a first axially extending groove in one of the first and second conduits and extends into a second groove in the other of first and second conduits that provides an axially extending, fixed path for electric bonding member to substantially prevent rotation of one conduit relative to the other.

13. A fluid line assembly, comprising:
a first fluid conveying conduit;
a second fluid conveying conduit; and
a slip joint including a first fluid conveying conduit section, a second fluid conveying conduit section positioned radially outwardly from the first conduit section, and an electrical bonding device positioned between and contacting the first and second fluid conveying conduit sections to form an electrical path therebetween, the electrical bonding device including at least one generally resilient, electrical bonding member compressed between the first and second fluid conveying sections, wherein compression of the electrical bonding member and electrical resistance between the first and second fluid conveying conduits is generally constant during relative movement therebetween.

14. A fluid line assembly, comprising:
a first fluid conveying conduit;
a second fluid conveying conduit; and
a slip joint including a first fluid conveying conduit section, a second fluid conveying conduit section positioned radially outwardly from and at least partially surrounding the first conduit section, and an electrical bonding device positioned between and contacting the first and second fluid conveying conduit sections to form an electrical path therebetween, the electrical bonding device including at least one cantilevered, generally resilient, electrical bonding member received in an axially extending groove in one of first and second conduits and compressed between the first and second fluid conveying sections, wherein compression of the electrical bonding member and electrical resistance between the first and second fluid conveying conduits is generally constant during relative movement therebetween.
